(19) United States
(12) Patent Application Publication
(10) Pub. No.: US 2026/0352041 A1
(43) Pub. Date: Nov. 5, 2026

(54) STATOR FOR A RADIAL FLUX DOUBLE ROTOR MACHINE AND RADIAL FLUX DOUBLE ROTOR MACHINE

(71) Applicant: DeepDrive GmbH, Garching (DE)

(72) Inventors: Jannik Stammler, Stuttgart (DE); Felix Bensing, Stuttgart (DE); Valentin Unterfrauner, Munich (DE)

(21) Appl. No.: 19/629,627

(22) Filed: Mar. 26, 2026

(30) Foreign Application Priority Data
Apr. 30, 2025 (DE) 102025116817.2

(51) Int. Cl. H02K 1/16; H02K 3/24; H02K 3/50

(52) U.S. Cl. CPC H02K 1/165; H02K 3/24; H02K 3/50

(57) ABSTRACT

The present invention relates to a stator for a radial flux double rotor machine. A winding is placed in the stator core and formed with conductor bars with opposite angles of inclination, wherein the stator lamination stack has stator slots corresponding to a winding path of the winding and running in the stator core, which are respectively designed to receive an individual conductor bar of the winding. A support device is arranged axially offset from the stator core, which is designed for torque support of the winding at an axial end. Additional stiffening elements are provided between inner contours of the respective stator slots and conductor bars placed in the respective stator slots for structurally connecting the stator lamination stack and the conductor bars.

### CROSS REFERENCE TO RELATED APPLICATION

This application claims the benefit of German Patent Application DE 102025116817.2, filed Apr. 30, 2025, the content of which is hereby incorporated by reference in its entirety.

### FIELD OF THE INVENTION

The present disclosure relates to a stator for a radial flux double rotor machine. The invention further relates to a radial flux double rotor machine having such a stator.

### TECHNICAL BACKGROUND

Electric machines with one stator and two rotors connected to one another in a rotationally fixed manner, so-called double rotor machines (in addition to double rotor also referred to as multiple rotor, dual rotor, etc.) can increase both the torque density and efficiency of electric drives compared to conventional electric machines with just one rotor. This is due to the fact that in particular in the so-called “yokeless” design, no magnetic return path is required in the stator and as a result the core losses can be significantly reduced. In addition, two rotors generally provide more space for the field-exciting magnets (in permanent magnet synchronous machines, PSMs) or the conductor material (in induction machines, IMs, or electrically excited synchronous machines, ESMs). Depending on the orientation of the magnetic field lines in the air gap, such machines can be divided into two groups, axially flux-carrying on the one hand (field lines parallel to the axis of rotation, so-called axial flux machines) and radially flux-carrying on the other hand (field lines in the radial direction in the air gap, so-called radial flux machines).

Radial flux double rotor machines are disclosed, for example, in DE 10 2021 003 942 A1. They are characterised by a high torque and power density. These radial flux double rotor machines generally use established manufacturing methods suitable for large-scale production for the winding and laminated core and enable the torque generated in the stator core to be supported. For example, the publication DE 10 2023 101 990 B3, which is based on this, describes the particularly advantageous manufacture of a winding head with bent conductors.

The stator, as one of the critical components of a radial flux double rotor machine, substantially has a stator core, a winding placed in the stator core and a support for supporting the torque generated. The structural integrity of the stator is significant as a relative displacement between the components can result in efficiency losses or short-circuits.

### SUMMARY OF THE INVENTION

In this context, one of the ideas of the present invention is to provide a stator for a radial flux double rotor machine with a high degree of structural integrity, in particular a high degree of strength and rigidity.

Accordingly, the following is provided:
A stator for a radial flux double rotor machine, having a stator core, which has a stator lamination stack; a winding placed in the stator core and formed with conductor bars with opposite angles of inclination, wherein the stator lamination stack has stator slots corresponding to a winding path of the winding and running in the stator core, which are respectively designed to receive an individual conductor bar of the winding; and at least one support device arranged axially offset from the stator core, which is designed for torque support of the winding at an axial end; wherein additional stiffening elements are provided between inner contours of the respective stator slots and conductor bars placed in the respective stator slots for structurally connecting the stator lamination stack and the conductor bars.
A radial flux double rotor machine, in particular for a wheel hub drive, having: a mechanically fixed base; a stator according to the invention, wherein the support device is supported on the base for torque support of the winding; a first rotor arranged radially within the stator core; and a second rotor arranged radially outside the stator core.

The principle underlying the present invention is that a torque supported on the conductor bars can cause local deformations and/or stress peaks within the stator lamination stack, which require additional stiffening to increase the structural integrity within the stator lamination stack and the conductor bars.

The idea of the present invention is to provide additional structurally effective stiffening elements within the stator slots between the conductors and slot insides, in particular in addition to insulation of the conductor bars. In this way, the stator lamination stack is interspersed with the stiffening elements, which also directly extend along the conductor bars with opposite angles of inclination and thus along the load paths for torque support. In this way, continuous stiffening of the stator is achieved, such that, on the one hand, an increased torque can be supported and, on the other hand, stresses can be distributed along the stiffening elements and thus stress peaks can be effectively avoided.

A stator lamination stack is in particular to be understood as a stack of insulated electrical sheets, which are designed and provided for flux guidance. It may therefore be an electrical lamination. In other embodiments, however, it may also be a non-laminated core, for example an additively manufactured version of a plurality of insulated flux-guiding layers as a stator lamination stack. It is thus a functional designation, which does not necessarily have to be formed from actual sheets.

Conductor bars with opposite angles of inclination are to be understood as a bar arrangement with an opposite orientation of the angle of inclination. For this purpose, the conductor bars can be arranged in at least two layers. The first layer has a first inclined orientation, while the second layer is inclined in the opposite direction. The winding can in particular be designed as a framework of bars made of individual conductor bars.

A support device can be designed for positive engagement with the winding, for example by engagement with the conductor bars. It can be a separate component or a functional device integrated with other components. For example, integration with a housing or end plate would be conceivable. However, the support device can also be a support device connected in a material-locking manner to the winding, for example designed as a casting of the winding head.

The stiffening elements are in particular designed to structurally connect the sheet metal laminations and further serve to restrict the degree of freedom between conductor bars and stator slots. The stiffening elements also enable the conductors to be inserted into the stator slots with force, without damaging insulating layers of the conductor bars in the process.

Advantageous embodiments and further developments result from the further dependent claims and from the description with reference to the figures of the drawing.

According to one embodiment, the stiffening elements at least partially surround the conductor bars in the respective stator slots. In this way, the conductor bars can be supported on the stiffening elements on a plurality of sides, in particular also on opposite sides. A force fit is thus preferably created the conductor bar and slot inner surface.

According to one embodiment, the stiffening elements contain an expandable material, which can be expanded by at least 5 percent by volume in the pre-assembled or assembled state for structurally connecting the stator lamination stack and the conductor bars within the stator slot. The conductor bars are inserted into the stator slots for manufacturing either subsequent to or together with the stiffening elements. Depending on the fit, in the case of a transition fit provided prior to expansion, a smaller expansion is necessary, and in the case of a clearance fit, a larger expansion is necessary to create the structural assembly and, in particular, a force fit and/or form fit. The expansion is preferably irreversible, such that a solid structural assembly is then created. For example, the stiffening elements can be designed to be expandable in a range of at least 5% to no more than 150% in order to produce the structural assembly within the stator slot in a stable manner. In particular the expansion is at least 10 percent by volume. In other embodiments, the expansion is at least 50 percent by volume. In the event of free expansion, expansion of the material can assume even greater proportions, for example up to 500%.

According to one embodiment, the stiffening elements have a plastic with irreversible expansion properties that can be thermally activated. Alternatively or in addition, the stiffening elements have adhesive substances, in particular plastics. These are preferably adhesive substances with irreversible expansion properties that can be thermally activated. The expansion properties advantageously create both tolerance compensation and a combination of material-locking and force-fit connection. A positive connection can also be created by expansion at the slot ends beyond the slot insides.

According to one embodiment, the stiffening elements contain an electrically insulating material. In this way, they additionally contribute to electrical safety and protection from short circuits.

According to one embodiment, the stiffening elements are designed as single-piece elements. Multi-piece, in particular two-piece, embodiments are also possible. The stiffening elements further have contours which engage around radially inner and outer surfaces of the conductor bar. The respective conductor bar is thus enclosed by the respective stiffening element.

According to one embodiment, the winding protrudes beyond the stator core at a first axial end and a second axial end opposite the first axial end, wherein the stiffening elements respectively have a protruding part at the first or second axial end or at both axial ends. In this way, the stiffening element can also provide axial stiffening by additionally limiting an axial degree of freedom.

According to one embodiment, at least one stiffening element is arranged in each stator slot and is positioned between the conductor bar and the inner contour of the stator slot and between the conductor bar and the support device. In particular, the stiffening element extends with the protruding part between the conductor bar and support device. The connection between the conductor bar and support device is thus also reinforced and structurally connected with the stiffening element.

According to one embodiment, the support device is designed with openings for supporting the winding at the first axial end. The protruding part of the stiffening element is arranged between the respective conductor bar and the respective opening of the support device and is provided for structurally connecting the support device and the conductor bars. In this way, the connection between the conductor bar and support device is advantageously also reinforced by means of the stiffening elements. The stiffening element is designed, in particular in an expandable embodiment, to compensate for tolerances of the openings. Alternatively or in addition, expansion of the stiffening element creates a step or undercut on the respective opening and thus ensures that the conductor bar is axially fixed in the opening or at least that the stiffening element is axially fixed. The openings can in particular be wedge-shaped or conical for reinforcing the axial fixation.

According to one embodiment, the stiffening elements respectively have at least one longitudinal, in particular slot-like or elongated hole-shaped, recess, which runs longitudinally along the conductor bar within the stator slot. A plurality of longitudinal recesses are also possible. In one embodiment, these may run parallel to one another. In other embodiments, these can also run in sections one after the other or in a line.

According to one embodiment, the stiffening elements contain a foldable material. The stiffening elements are designed to be folded around the conductor bars within the stator slots. In a joint region of the folded material, the stiffening elements can have an overlap or a free region. A respectively folded connection region of the stiffening element arranged in the respective stator slot runs around an edge of the respective conductor bar arranged in the stator slot. Alternatively or in addition, the folded connection region runs along an inner edge of the respective inner contour of the stator slot. In this way, the stiffening element can advantageously be folded to a greater extent for insertion into the stator slot and unfolded in the inserted state, such that friction during insertion and any resulting damage can be prevented. Furthermore, the position of the stiffening element on the conductor bar or within the slot is predetermined by the folded connection region and is adjusted independently or in a self-adjusting manner in particular by elastic deformation.

According to one embodiment, the foldable material is designed as a multi-layer composite material with at least one centrally arranged support layer, in particular film. Alternatively or in addition, the multi-layer composite material contains an expansion layer and/or an adhesion layer. In this way, a plurality of functions can be integrated into the stiffening element, in particular in addition to stiffening, a connection function, an insulation function and/or a tolerance compensation function.

According to another embodiment, the foldable material contains a laminate. According to another embodiment, the foldable material contains a flat product, in particular made of plastic. According to another embodiment, the foldable material contains a thin-layer moulded part. According to another embodiment, the foldable material contains a profile. According to other embodiments, the foldable material contains a film. Common to all these embodiments is that stiffening of the stator is achieved by providing and arranging the respective stiffening elements in the stator slots between the slot inner surface and conductor outer surface, optionally also between the inner surface of the openings of the support device and conductor outer surface.

According to one embodiment, the stiffening elements contain a sealing material and the respective stator slot is fluidically sealed by the stiffening element arranged in the stator slot. Undesired ingress or escape of liquids or even of gases is thus advantageously prevented and targeted fluid guidance enabled.

According to one embodiment, the longitudinal recess is designed and arranged as a conduit delimited by the stator slot and the conductor bar for axial coolant flow from one to the other of the first and second axial ends of the stator. In this way, further functional integration is advantageously achieved by using the stiffening element simultaneously to form a coolant conduit.

According to one embodiment, an axial end of the stiffening element is folded over to form a fold. In this way, an integral axial stop is advantageously provided when inserting the stiffening element into the stator slot. In the case of an expandable stiffening element, such a folded-over fold also has double the expansion capability thanks to its double layer. In particular, an undercut can thus be formed behind the support device thanks to expansion, which can be used, for example, for axial fixation. In one advantageous embodiment, one end of the longitudinal recess is likewise recessed in the folded-over fold, for example with a corresponding recess. This recess can thus advantageously be used as an inlet or outlet if configured as a coolant conduit.

According to one embodiment, the winding has an inner conductor layer and an outer conductor layer, wherein the folds of the inner conductor layer and outer conductor layer are positioned at opposite axial ends of the stator. In this way, opposite insertion directions of the stiffening elements can be achieved, which are in particular consistent with the insertion directions of conductor bars bent at opposite ends. This is in particular provided in a winding formed from interconnected conductor bars, which has a radially inner layer of helically arranged conductor bars and a radially outer layer of opposite helically arranged conductor bars, wherein the conductor bars are respectively bent at a first conductor bar end and not bent at a second conductor bar end. The first conductor bar ends of the conductor bars of the radially outer layer are arranged in such a way that the bend is respectively oriented radially inwards. The first conductor bar ends of the conductor bars of the radially inner layer are arranged in such a way that the bend is respectively oriented radially outwards.

According to one embodiment, free regions of the stiffening element, which are formed by virtue of the fact that the stiffening element is shorter than the circumference of the conductor bar, are designed and arranged as a conduit delimited by the stator slot and the conductor bar for axial coolant flow from one to the other of the axial ends of the stator. Of course, the stiffening elements contain a sealing material and the respective stator slot is fluidically sealed by the stiffening element arranged in the stator slot. In this way, functional integration is advantageously achieved by using the stiffening element simultaneously to form a coolant conduit without the need for additional materials.

The above embodiments and further developments can be combined with one another in any way that makes sense. Other potential embodiments, further developments and implementations of the invention also comprise not explicitly mentioned combinations of features of the invention described above or below in relation to the exemplary embodiments. In particular, a person skilled in the art will also add individual aspects as improvements or additions to the respective basic form of the present invention.

### SUMMARY OF THE DRAWING

The present invention will be explained in more detail below based on the exemplary embodiments specified in the schematic figures of the drawing. In the drawing:

FIG. 1 is a schematic illustration of a stator for a radial flux double rotor machine in longitudinal section;

FIG. 2 is a schematic illustration of a radial flux double rotor machine in longitudinal section;

FIG. 3 is a perspective illustration of a stator for a radial flux double rotor machine according to one embodiment;

FIG. 4A, 4B are perspective detail views of a stator in the winding head region;

FIG. 5A, 5B are perspective detail views of a stator in the region of the support device;

FIG. 6 is a front view of a stiffening element according to one embodiment;

FIG. 7 is a perspective illustration of a stiffening element according to one embodiment;

FIG. 8 is a detail view in cross-section of a stator with stiffening elements according to FIG. 7;

FIG. 9 is a schematic illustration of a stator for a radial flux double rotor machine in longitudinal section according to another embodiment;

FIG. 10 is a perspective illustration of a stiffening element according to one embodiment;

FIG. 11 is a detail view in cross-section of a stator with stiffening elements according to FIG. 10;

FIG. 12A, 12B are perspective detail views of a stator in the winding head region with stiffening elements according to FIG. 10;

FIG. 13 is a perspective illustration of a stiffening element according to another embodiment;

FIG. 14 is a perspective detail view of a stator in the winding head region with stiffening elements according to FIG. 13;

FIG. 15 is a detail view in cross-section of a stator with stiffening elements according to FIG. 14;

FIG. 16 is a perspective illustration of a stiffening element according to yet another embodiment;

FIG. 17 is a perspective detail view of a stator in the winding head region with stiffening elements according to FIG. 16;

FIG. 18 is a perspective illustration of a support device according to one embodiment; and

FIG. 19A, 19B is a perspective illustration of a two-part support device according to one embodiment.

The appended figures of the drawing are intended to provide further understanding of the embodiments of the invention. They illustrate embodiments and serve to explain the principles and concepts of the invention in connection with the description. Other embodiments and many of the advantages mentioned result from the drawings. The elements in the drawings are not necessarily shown to scale.

Identical, functionally identical and identically acting elements, features and components respectively bear the same reference numerals in the figures of the drawing, unless otherwise stated.

### DESCRIPTION OF EXEMPLARY EMBODIMENTS

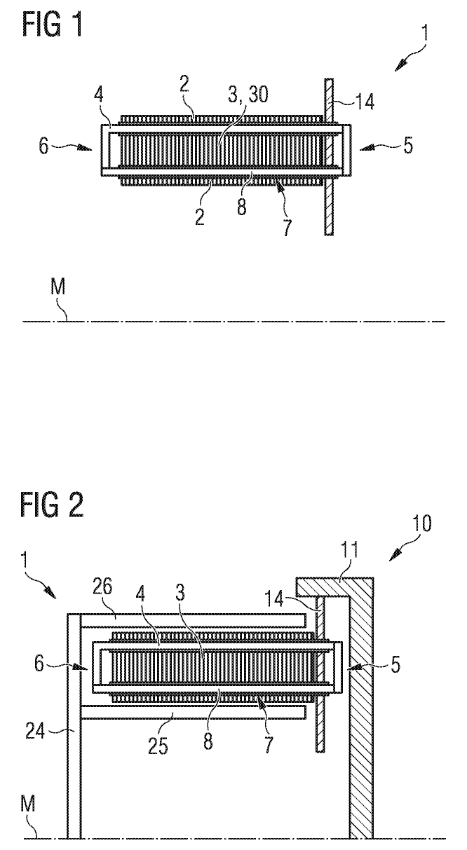

FIG. 1 shows a schematic illustration of a stator 1 for a radial flux double rotor machine in longitudinal section.

The stator 1 is designed for a radial flux double rotor machine 10 (FIG. 2), such that it can be supported against a base on only one side, in this case a first axial end 4, for example shown on the right-hand side in FIG. 1. On the other side, in this case the second axial end 6, the stator is designed to be surrounded by a double rotor.

The stator has a stator core 3, which contains a stator lamination stack 30. A winding 4 is placed in the stator core 3 and formed with conductor bars 8 with opposite angles of inclination. For the sake of clarity, the inclination of the conductor bars 8 is not shown here, i.e. the figure should be understood to be schematic in this respect.

The stator lamination stack 30 has stator slots 7 running through or in the stator core 3, which receive the conductor bars 8. Each of the stator slots is respectively designed to receive an individual conductor bar 8 of the winding 4. The stator slots 7 correspond in their path to the winding path of the winding 4. An inclination is not shown here either for the sake of simplicity; the figure should be understood as schematic in this respect.

Additional stiffening elements 2 are provided between the inner contours of the respective stator slots 7 and the conductor bars 8, which are placed in the respective stator slots 7. These are designed to structurally connect the stator lamination stack 30 and the conductor bars 8. They run along the conductor bars 8 and extend axially through the stator core within the stator slots 7.

A support device 14 is arranged axially offset from the stator core 3, which is designed for torque support of the winding 4 at an axial end 5. The stiffening elements optionally extend further axially, in particular, as also shown schematically here, from the stator core axially further into the support device 14.

The stator 1 is designed to be substantially rotationally symmetrical about the schematically illustrated central axis M, which is obvious to a person skilled in the art.

FIG. 2 shows a schematic illustration of a radial flux double rotor machine 10 in longitudinal section.

The radial flux double rotor machine 10 is in particular designed for a wheel hub drive of a vehicle. It can, however, also be a central drive of a vehicle, in particular motor vehicle. Further more, different types of applications outside of vehicle technology are also conceivable, such as in robotics.

The radial flux double rotor machine 10 has a stator according to FIG. 1 and a mechanically fixed base 11, which can be part of a machine housing. For example, it can be designed as an end plate or coupled in another way to the machine housing for torque support. The stator 1 according to FIG. 1 is shown schematically in FIG. 2 purely by way of example on the right-hand side supported on the base 11 with the support device 14 for torque support of the winding 4.

A double rotor 24 is arranged on the left-hand side in FIG. 2. It has a first rotor 25 arranged radially within the stator core 3 and a second rotor 26 arranged radially outside the stator core 3, which are mounted in this case, for example, on a common rotor head of the double rotor 24. The double rotor 24 is designed to rotate about the central axis M driven by currents in the winding.

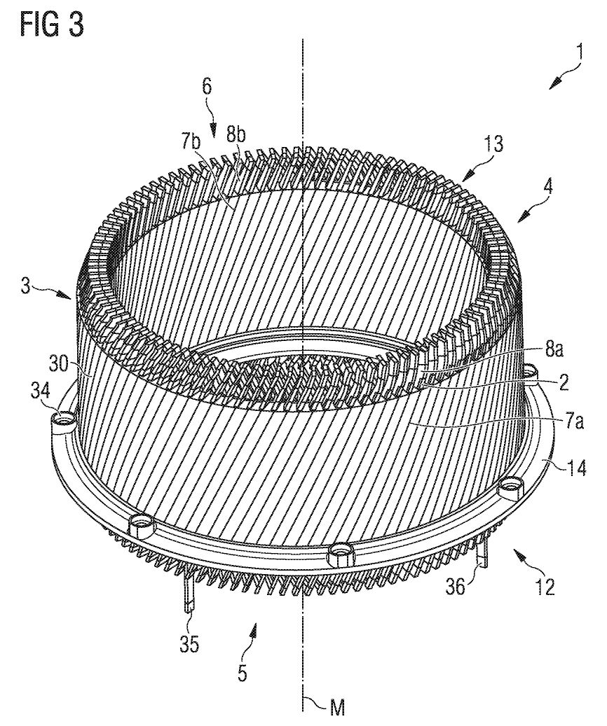

FIG. 3 shows a perspective illustration of a stator 1 for a radial flux double rotor machine 10 according to one embodiment.

It shows the opposite inclination of the conductor bars 8 within the stator lamination stack 30. The winding 4 contains a radially outer layer of conductor bars 8a, which run at an angle, in particular helically, within the radially outer stator slots 7a. Furthermore, the winding 4 contains a radially inner layer with conductor bars 8 running at an opposite angle, in particular in an oppositely helical manner.

The support device 14 is arranged at a first axial end 5 shown at the bottom in FIG. 3. The support device 14 is designed here with openings 9 in the dimension of the conductor cross-section, such that the conductor bars run through them and such that torque generated during operation is supported via the winding 4 on the support device 14. The support device 14 can in turn be attached to a machine housing, in this case for example with a plurality of fastening means which can be provided at fastening points 34.

A second winding head 13 is formed at a second axial end shown here at the top of FIG. 3. The conductor bars are designed to be bent at respectively one axial end and welded or soldered to one another. For the embodiment of the winding heads with bent conductor bars and their production, reference is made to document DE 10 2023 101 990 B3, the disclosure of which is incorporated herein in its entirety.

Unlike the disclosure of document DE 10 2023 101 990 B3, in the embodiment shown, the additional stiffening elements 2 are provided between the inner contours of the respective stator slots 7 and the conductor bars placed in the respective stator slots 7. For example, in the embodiment shown, the stiffening elements 2 at least partially surround the conductor bars 8 in the respective stator slots 7. The stiffening elements preferably extend along the entire stator slots, in particular continuously.

The stiffening elements 2 can contain an expandable material, which is irreversibly expanded by at least 5 percent by volume in the pre-assembled or assembled state for structurally connecting the stator lamination stack 30 and the conductor bars 8 within the stator slot 7. In other embodiments, the expandable material can also be expanded by 10 percent by volume or more, depending on the fit of the conductor bars in the stator slots. In other embodiments, expansions of up to 150 percent by volume are conceivable. For example, the expandable material can have a plastic with irreversible expansion properties that can be thermally activated and alternatively or in addition adhesive substances. In this way, the stator is structurally reinforced and stiffened throughout by expanding or activating all stiffening elements. Otherwise customary casting materials can thus advantageously be dispensed with. The structural integrity of the overall stator in the assembled state of the individual parts is established after expansion or activation by the stiffening elements.

Electrical connection pins 35, 36 are also shown, which are designed to connect the winding 4 to power electronics, in particular an inverter.

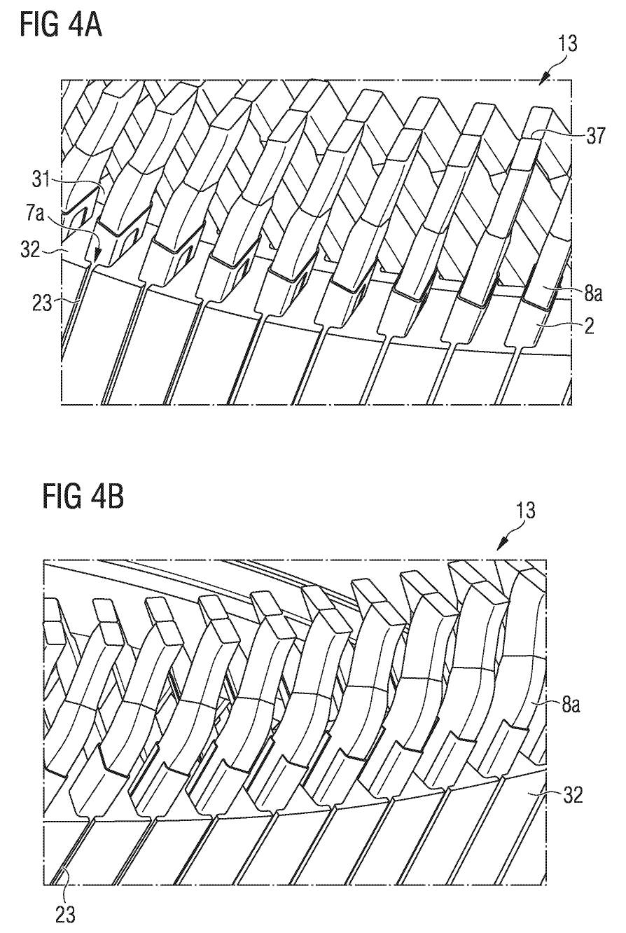

FIG. 4A, 4B show perspective detail views of a stator 1 in the winding head region.

It is the free-standing second winding head 13, shown at the top of FIG. 3, on the second axial end 6 of the stator 1. In the embodiment shown, at this end, the conductor bars 8 of the outer layer of conductor bars 8a are bent and the conductor bars 8 of the inner layer of conductor bars 8b are straight. At the end of the conductor bars, these form a joint 37, which is conductively and firmly connected in particular by laser beam welding. Other conductive connection techniques such as soldering etc. are also conceivable.

The winding 4 protrudes beyond the stator core at the second axial end shown, wherein the stiffening elements also protrude with a protruding part beyond the stator core 3 at the first axial end 5 and a second axial end 6 opposite the first axial end 5.

The stiffening elements 2 received in the stator slots 7 can be single-piece or multi-piece elements. They surround a plurality of surfaces, in particular radially inner and outer surfaces of the conductor bar 8 and engage around these with correspondingly engaging contours. In the embodiment shown here, they are designed as single-piece elements, for example, and are provided with recesses 19. However, in other embodiments, other designs are also conceivable, in particular without recesses or with differently placed recesses as well as with multi-part designs.

In the embodiment shown, the stator lamination stack 30 is, purely by way of example, designed as a two-piece stack and has an inner sub-stack 31, in which the inner stator slots 7b are formed, and an outer sub-stack 32, in which the outer stator slots 7a are formed. In other embodiments, other structures of the stator lamination stack 30 are also conceivable, such as single-piece, additively manufactured, or the like.

The radially outer stator slots respectively have a flux-interrupting grooved slot 23 on the side facing radially outwards, such that magnetic flux is largely prevented in the circumferential direction and radial flux prevails during operation. The stator lamination stack 30 preferably contains a soft-magnetic material.

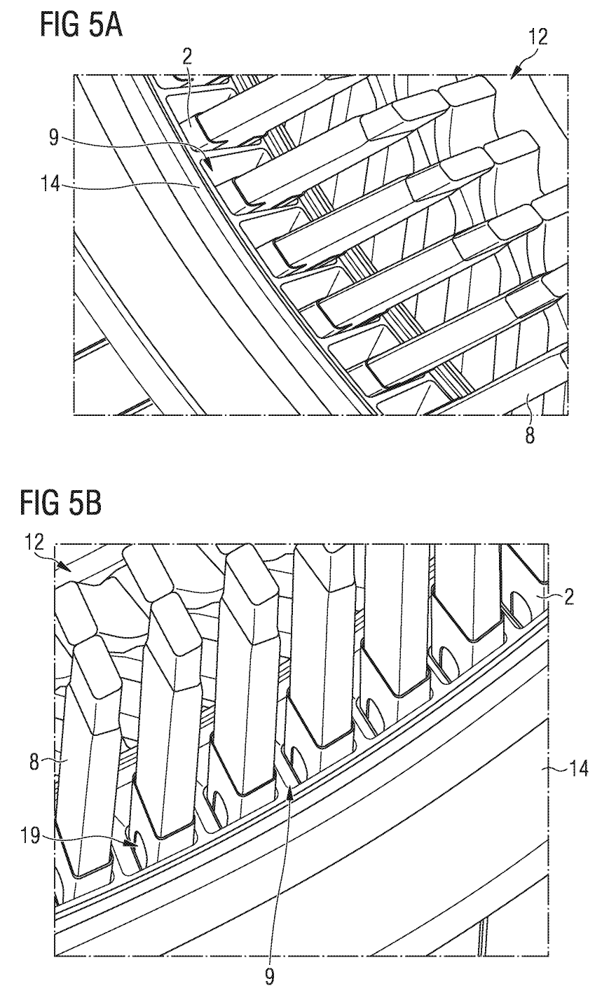

FIG. 5A, 5B show perspective detail views of a stator 1 in the region of the support device 14.

This is the first axial end 5 with the first winding head 12.

The stiffening elements 2 respectively have a protruding part on this first axial end 5 too. At least one stiffening element 2 is arranged in each stator slot 7 and is positioned between the conductor bar 8 and the inner contour of the stator slot 7. Furthermore, the protruding part of the stiffening elements on the first end 5 shown is additionally positioned between the conductor bar 8 and the support device 14. The support device 14 is designed with openings 9 for supporting the winding 4 at the first axial end 5. The protruding part also runs between the respective conductor bar 8 and the respective opening 9 of the support device 14 and is provided and designed for structurally connecting the support device 14 and the conductor bars 8.

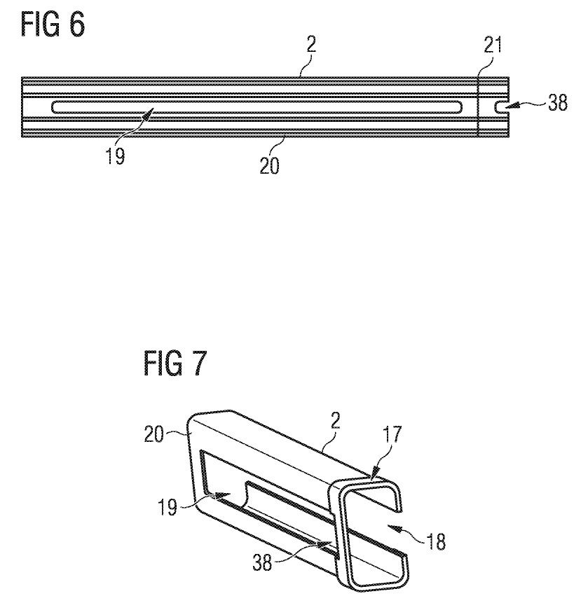

FIG. 6 shows a front view of a stiffening element 2 according to one embodiment.

In the configuration shown, this is a foldable stiffening element 2. Foldable stiffening elements 2 contain a foldable material and are designed to be folded around the conductor bars 8 within the stator slots 7. Such a foldable material is designed,, for example, as a multi-layer composite material with at least one expansion layer. Alternatively or in addition, a centrally arranged support layer, in particular film, or an expansion layer or an adhesion layer or a combination thereof can be contained. Other embodiments of the foldable material can contain a laminate. A flat product made of plastic or a thin-layer moulded part, a profile or a film are also conceivable.

According to the embodiment shown here, the stiffening elements 2 respectively contain at least one longitudinal, in this case slot-like or elongated hole-shaped, recess 19. In the assembled state, the recess 19 runs longitudinally along the conductor bar 8 within the stator slot 7.

An axial end of the stiffening element 2 is also prepared for forming a fold 17. For example, it has a fold preparation 21 at a predetermined position and a continuation of the recess 19. In the embodiment shown, it is, for example, a recess 38 corresponding to the recess in the folded-over state.

FIG. 7 shows a perspective illustration of a stiffening element 2 according to one embodiment.

An already folded-over fold 17 is provided here, likewise with continuation of the recess 19 at the folded-over end. The fold 17 also forms a stop here for limiting the insertion of the stiffening element 2 into a stator slot 7 and thus ensures predetermined positioning within the stator core.

Moreover, the stiffening element 2 here also has a free region 18, which can be formed by virtue of the fact that the stiffening element 2 is shorter than the circumference of a conductor bar 8 to be surrounded. The sides of the stiffening element 2 are connected with connection regions 20, in this case for example in the form of rounded corners.

The cross-section of the stiffening element is constant over the length in this embodiment. However, variable cross-sections are also conceivable in other embodiments, in particular with a cross-sectional change adapted to the conductor bar contour or the stator slot inner contour over the length.

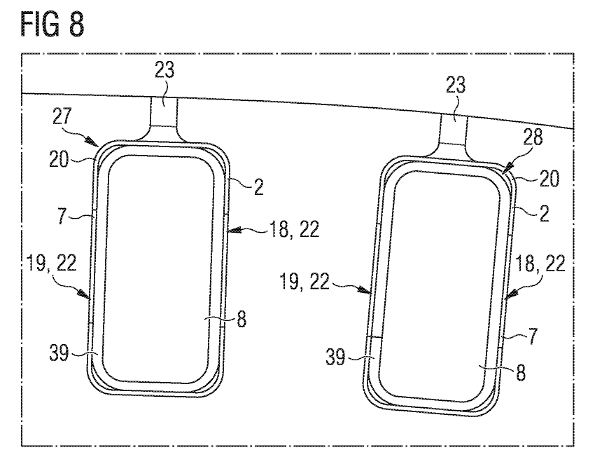

FIG. 8 shows a detail view in cross-section of a stator 1 with stiffening elements 2 according to FIG. 7.

The stiffening elements 2 are arranged between the outer contours of the conductor bars 8 and the inner contours of the stator slots 7 within the stator slots 7. A connection region 20, folded here for example by around 90°, of the stiffening element 2 arranged in the respective stator slot 7 runs respectively around an edge 28 of the respective conductor bar 8 arranged in the stator slot 7 and along an inner edge 27 of the respective inner contour of the stator slot 7. The contours of the stator slots and correspondingly the folded angle are not fixed, but rather can be adapted to the conductor bar contour, which can be designed differently depending on the application.

In one embodiment, the stiffening elements 2 contain an electrically insulating material. Another insulator and an additional protection from short circuits are thus integrated in addition to the insulating layer 39 of the conductor bars. In one embodiment, the stiffening elements 2 also contain a sealing material. The insulating material and the sealing material can also be the same material. The respective stator slot 7 is thus also fluidically sealed by the stiffening element 2 arranged in the stator slot 7. The sealing makes it possible that recesses 19 or free regions 18 of the stiffening element 2 can be designed and arranged as a conduit 22 delimited by the stator slot and the conductor bar for axial coolant flow from one to the other of the axial ends 5, 6 of the stator.

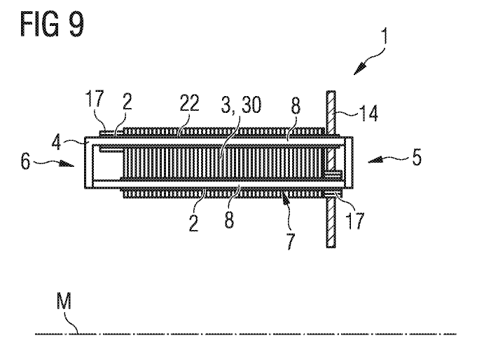

FIG. 9 shows another schematic illustration of a stator 1 for a radial flux double rotor machine 10 in longitudinal section according to one embodiment.

The illustration is based on FIG. 1 and is also intended to illustrate the possible arrangement of the folds 17 of the stiffening elements 2 and the possible path of the longitudinal recess 19. For the sake of simplicity, the inclination of the conductors, as in FIG. 1, are not shown here either.

The longitudinal recess 19 is used as a conduit 22 delimited by the stator slot 7 and the conductor bar 8 for axial coolant flow from one to the other of the first and second axial ends 5, 6 of the stator. The stiffening element contains a sealing material, as explained in relation to FIG. 8.

Furthermore, the folds 17 of the radially inner conductor layer and the radially outer conductor layer are positioned at opposite axial ends 5, 6 of the stator 1. The fold is preferably provided at the bent or angled end of the conductor bars 8.

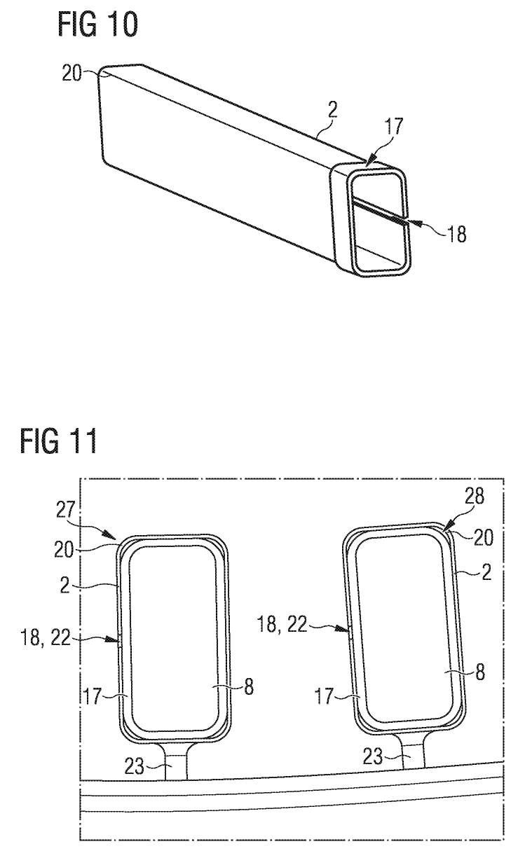

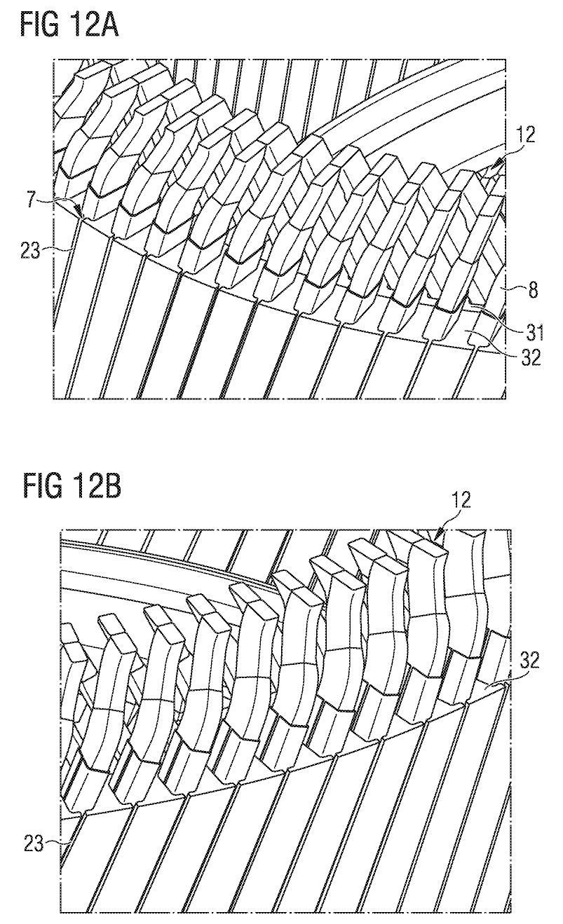

FIG. 10 shows a perspective illustration of a stiffening element 2 according to one embodiment. FIG. 11 shows a detail view in cross-section of a stator 1 with stiffening elements according to FIG. 10. FIG. 12A, 12B show perspective detail views of a stator 1 in the winding head region with stiffening elements according to FIG. 10.

In this exemplary further embodiment, no recess is provided in the material, and only a relatively small free region 18 is provided on one of the long sides of the stiffening element. The free region can nevertheless form a conduit 22.

FIG. 13 shows a perspective illustration of a stiffening element according to yet another embodiment.

In this exemplary further embodiment, no recess is provided in the material either but, unlike FIG. 10, a free region 18 is not provided on one of the long sides, but rather on one of the short sides of the stiffening element 2. The free region can likewise form a conduit 22.

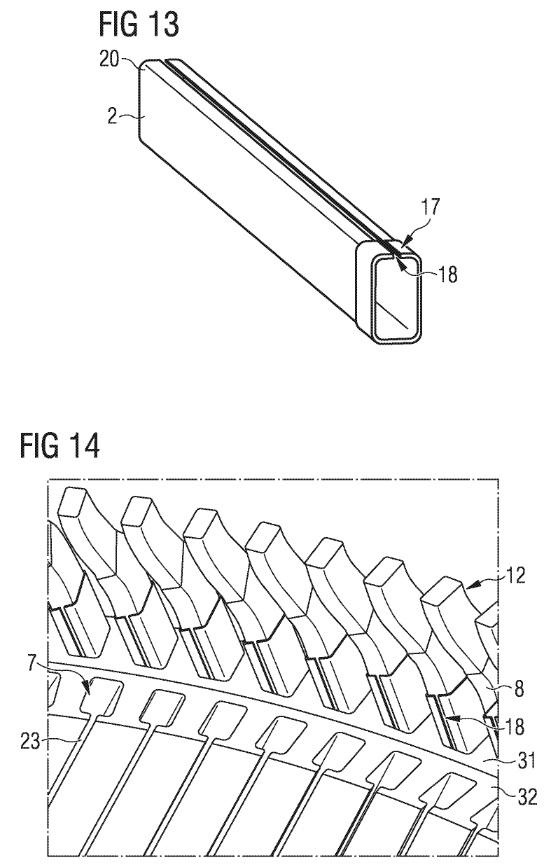

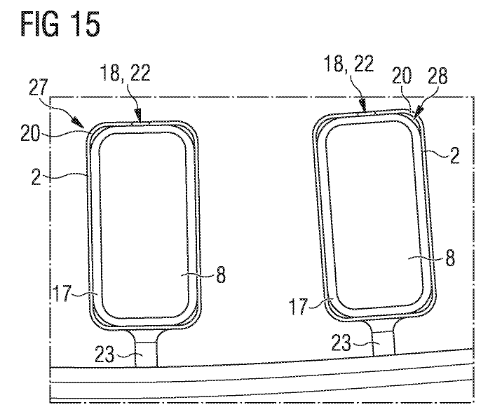

FIG. 14 shows a perspective detail view of a stator in the winding head region with stiffening elements according to FIG. 13.

For the sake of clarity, the conductor bars 8 of the radially inner conductor layer and the associated stiffening elements 2 are not shown here, such that the free regions 18, facing radially inwards here, of the radially outer stiffening elements 2 can be seen. A conduit 22 for cooling can thus be provided in a central region of the stator core that is particularly prone to thermal stress due to heat accumulation.

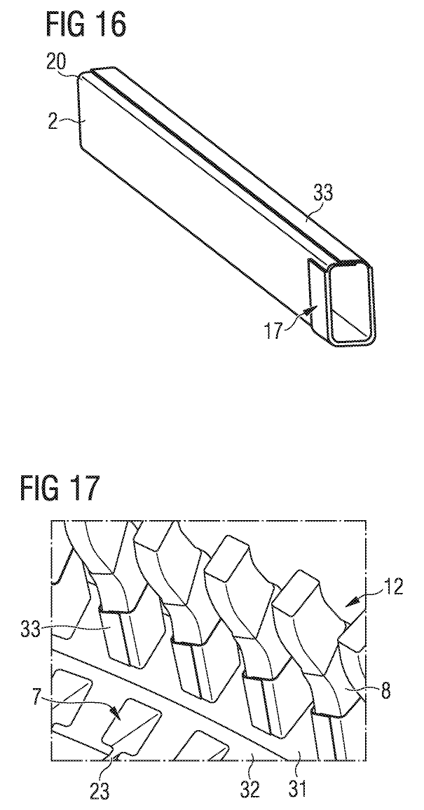

FIG. 15 shows a detail view in cross-section of a stator 1 with stiffening elements according to FIG. 14.

It also shows the positioning of the free regions 18 and conduit 22 formed thereby on the radially inner side of the outer layer of the stiffening elements 2.

FIG. 16 shows a perspective illustration of a stiffening element 2 according to yet another embodiment.

In this exemplary further embodiment, no recess is provided in the material either, and unlike FIGS. 11 or 14, no free region 18 is provided either. Rather, an overlap 33 of the stiffening element running along a short longitudinal side is provided here. This is provided in particular in addition to the fold 17.

In other embodiments, the overlap 33 can also be positioned on the long side.

FIG. 17 shows a perspective detail view of a stator in the winding head region with stiffening elements according to FIG. 16.

For the sake of clarity, the conductor bars 8 of the radially inner conductor layer and the associated stiffening elements 2 are not shown here either, such that the overlaps 33, facing radially inwards, of the radially outer stiffening elements 2 can be seen.

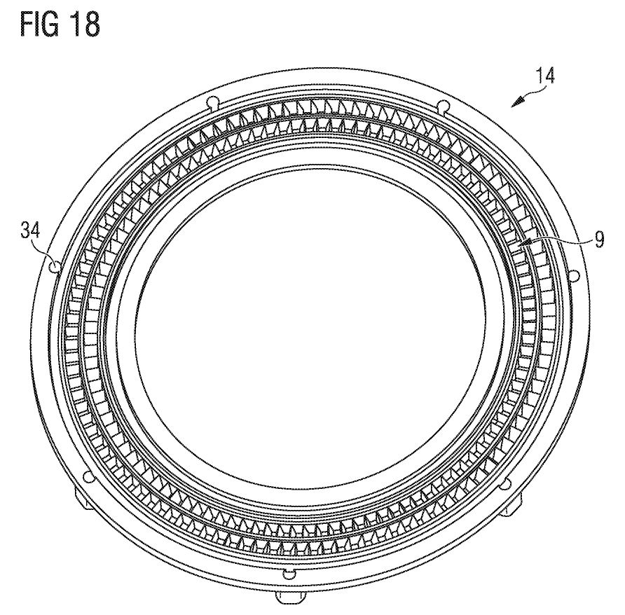

FIG. 18 shows a perspective illustration of a support device 14 according to one embodiment.

The support device 14 is annular in design and has a plurality of openings 9 arranged in two concentric rings for passing conductor bars through.

In the embodiment shown here, a path of the openings 9 is slanted and corresponds to an intended inclination of the conductor bars 8. The inclination of the radially inner openings is therefore opposite to the inclination of the radially outer openings. The inner surface of the openings is thus designed in such a way that it continues the inner surface of a corresponding stator slot at the axial end.

The support device 14 is designed so that it can be attached to a base, such as a machine housing. For this purpose, a plurality of fastening points 34, in this case purely by way of example seven, are provided and are used for attachment with fastening means. In other embodiments, a variety of other numbers of fastening points 34 are of course possible.

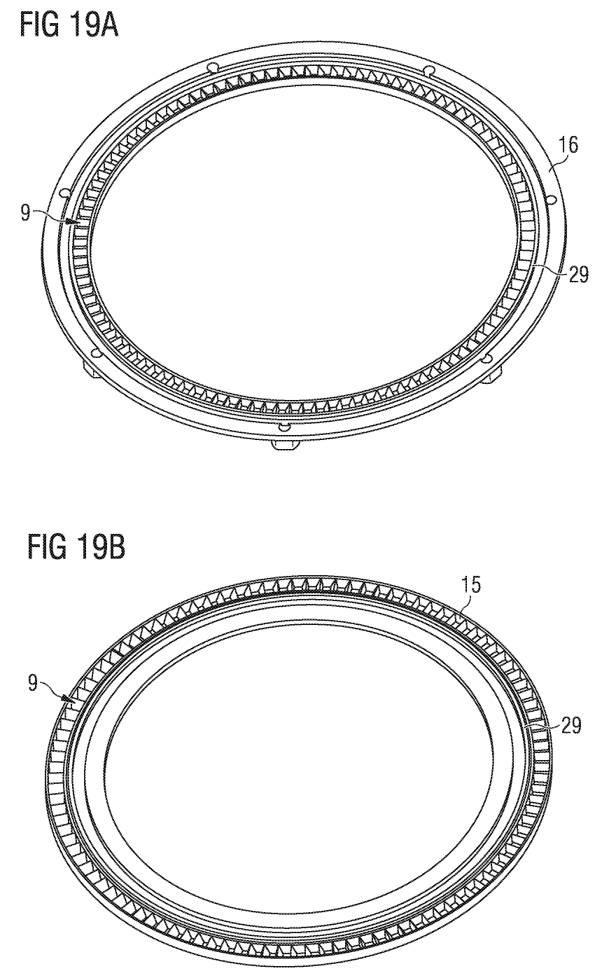

FIG. 19A and 19B show a perspective illustration of a support device 14 in a two-part design.

FIG. 19A shows an outer support part 16 with fastening points 34 and radially outer openings 9. FIG. 19B shows the inner support part 15 with radially inner openings 9.

Furthermore, a centring feature 29 is provided radially within the openings 9. In the embodiment shown, it is a step designed for centring. In this way, a contour protruding from the bearing surface on the stator stack is provided and enables centred alignment of the support device 14 with the stator core 3.

Although the present invention has been described above in full based on preferred exemplary embodiments, it is not limited thereto and can be modified in a variety of ways.

### REFERENCE LIST

1 stator
2 stiffening element
3 stator core
4 winding
5 first axial end
6 second axial end
7 stator slot
7a radially outer stator slots
7b radially inner stator slots
8 conductor bar
8a radially outer layer of conductor bars
8b radially inner layer of conductor bars
9 opening
10 radial flux double rotor machine
11 base
12 winding head
13 winding head
14 support device
15 inner support part
16 outer support part
17 fold
18 free region
19 recess
20 connection region
21 fold preparation
22 conduit
23 grooved slot
24 double rotor
25 first rotor
26 second rotor
27 inner edge
28 edge
29 centring feature
30 stator lamination stack
31 sub-stack
32 sub-stack
33 overlap
34 fastening points
35, 36 connection pins
37 joint
38 recess
39 insulating layer

What is claimed is:

1. A stator for a radial flux double rotor machine, having:
a stator core, which has a stator lamination stack;
a winding placed in the stator core and formed with conductor bars with opposite angles of inclination, wherein the stator lamination stack has stator slots corresponding to a winding path of the winding and running in the stator core, which are respectively designed to receive an individual conductor bar of the winding; and
at least one support device arranged axially offset from the stator core, which is designed for torque support of the winding at an axial end;
wherein additional stiffening elements are provided between inner contours of the respective stator slots and conductor bars placed in the respective stator slots for structurally connecting the stator lamination stack and the conductor bars.

2. The stator of claim 1,
wherein the stiffening elements at least partially surround the conductor bars in the respective stator slots.

3. The stator of claim 1,
wherein the stiffening elements contain an expandable material, which can be expanded, by at least 5 percent by volume, in the pre-assembled or assembled state for structurally connecting the stator lamination stack and the conductor bars within the stator slot.

4. The stator of claim 1,
wherein the stiffening elements have a plastic with irreversible expansion properties that can be thermally activated and/or adhesive substances.

5. The stator of claim 1,
wherein the stiffening elements contain an electrically insulating material.

6. The stator of claim 1,
wherein the stiffening elements are designed as single-piece or multi-piece elements and have contours engaging around radially inner and outer surfaces of the conductor bar.

7. The stator of claim 1,
wherein the winding protrudes beyond the stator core at a first axial end and a second axial end opposite the first axial end, wherein the stiffening elements respectively have a protruding part at the first and/or second axial end.

8. The stator of claim 1,
wherein at least one stiffening element is arranged in each stator slot and is positioned between the conductor bar and the inner contour of the stator slot and between the conductor bar and the support device.

9. The stator of claim 7,
wherein the support device is designed with openings for supporting the winding at the first axial end and the protruding part is arranged between the respective conductor bar and the respective opening of the support device and is provided for structurally connecting the support device and the conductor bars.

10. The stator of claim 1,
wherein the stiffening elements respectively have at least one longitudinal recess, which runs longitudinally along the conductor bar within the stator slot.

11. The stator of claim 1,
wherein the stiffening elements contain a foldable material and are designed to be folded around the conductor bars within the stator slots, wherein respectively one folded connection region of the stiffening element arranged in the respective stator slot runs around an edge of the respective conductor bar arranged in the stator slot or along an inner edge of the respective inner contour of the stator slot.

12. The stator of claim 11,
wherein the foldable material is designed as a multi-layer composite material with at least one insulating layer and/or an expansion layer and/or an adhesion layer, or the foldable material contains a paper, laminate or flat product.

13. The stator of claim 10,
wherein the stiffening elements contain a sealing material and the respective stator slot is fluidically sealed by the stiffening element arranged in the stator slot.

14. The stator of claim 10,
wherein the longitudinal recess is designed and arranged as a conduit delimited by the stator slot and the conductor bar for axial coolant flow from one to the other of the first and second axial ends of the stator.

15. The stator of claim 14,
wherein an axial end of the stiffening element is folded over to form a fold, which forms a stop for inserting the stiffening element into a stator slot, wherein one end of the longitudinal recess is likewise recessed in the folded-over fold.

16. The stator of claim 15,
wherein the winding has an inner conductor layer and an outer conductor layer, wherein the folds of the inner conductor layer and outer conductor layer are positioned at opposite axial ends of the stator.

17. The stator of claim 13,
wherein the stiffening elements contain a foldable material and are designed to be folded around the conductor bars within the stator slots with a free region, wherein the free regions of the stiffening element, which are formed by virtue of the fact that the stiffening element is shorter than the circumference of the conductor bar are designed and arranged as a conduit delimited by the stator slot and the conductor bar for axial coolant flow from one to the other of the axial ends of the stator.

18. The stator of claim 1,
wherein the stiffening elements contain an expandable material, which can be expanded, by at least 10 percent by volume in the pre-assembled or assembled state for structurally connecting the stator lamination stack and the conductor bars within the stator slot.

19. The stator of claim 1,
wherein the stiffening elements contain an expandable material, which can be expanded, by at least 50 percent by volume in the pre-assembled or assembled state for structurally connecting the stator lamination stack and the conductor bars within the stator slot.

20. Radial flux double rotor machine, having:
a mechanically fixed base;
a stator comprising:
a stator core, which has a stator lamination stack;
a winding placed in the stator core and formed with conductor bars with opposite angles of inclination, wherein the stator lamination stack has stator slots corresponding to a winding path of the winding and running in the stator core, which are respectively designed to receive an individual conductor bar of the winding;
at least one support device arranged axially offset from the stator core, which is designed for torque support of the winding at an axial end;
wherein additional stiffening elements are provided between inner contours of the respective stator slots and conductor bars placed in the respective stator slots for structurally connecting the stator lamination stack and the conductor bars;
wherein the support device is supported on the base for torque support of the winding;
a first rotor arranged radially within the stator core; and
a second rotor arranged radially outside the stator core.
